(19) United States
(12) Patent Application Publication
(10) Pub. No.: US 2017/0367330 A1
(43) Pub. Date: Dec. 28, 2017

(54) Method for stimulating induced insect resistance of rice

(71) Applicant: ZHENJIANG UNIVERSITY, Hangzhou, Zhejiang (CN)

(72) Inventors: Yonggen Lou, Hangzhou, Zhejiang (CN); Wanwan Wang, Hangzhou, Zhejiang (CN); Jun Wu, Hangzhou, Zhejiang (CN); Xingrui He, Hangzhou, Zhejiang (CN); Xiaochang Mo, Hangzhou, Zhejiang (CN); Nuo Jin, Hangzhou, Zhejiang (CN)

(21) Appl. No.: 15/540,029

(22) PCT Filed: Sep. 8, 2016
(86) PCT No.: PCT/CN2016/098384

§ 371 Date: Jun. 27, 2017

(30) Foreign Application Priority Data
Sep. 23, 2015 (CN) 201510613527.6

(51) Int. Cl. A01N 39/04

(52) U.S. Cl. CPC A01N 39/04

(57) ABSTRACT

A method for stimulating an induced insect resistance of rice is provided, which is effective to rice planthoppers, including Nilaparvata lugens, Sogatella furcifera, and Laodelphax striatellus. The present invention increases the resistance of the rice against rice planthoppers through p-Fluorophenoxyacetic acid, thereby decreasing damages of the rice planthoppers to the rice. Through applying the p-Fluorophenoxyacetic acid having a certain concentration to the rice, the rice generates the induced resistance against the rice planthoppers, which obviously decreases a survival rate of nymphs of the rice planthoppers.

### CROSS REFERENCE OF RELATED APPLICATION

This is a U.S. National Stage under 35 U.S.C 371 of the International Application PCT/CN2016/098384, filed Sep. 8, 2016, which claims priority under 35 U.S.C. 119(a-d) to CN 201510613527.6, filed Sep. 23, 2015.

### BACKGROUND OF THE PRESENT INVENTION

### Field of Invention

The present invention relates to a field of rice induced insect resistance, and more particularly to a method for stimulating an induced insect resistance of rice.

### Description of Related Arts

With the increase of the global population and the decrease of the agricultural acreage, people have higher and higher requirements on the per unit area yield of grain. The loss of the world grain yield, caused by the various insect damages, accounts for 10-30% of the total grain yield, and the total crop failure occurs in the heavy disaster year. Rice is one of the three major grain crops in the world, and nearly half of the world population, including almost the whole population of East Asia and Southeast Asia, feeds on the rice. In China, the perennial planting area of the rice is about 30 million hectares, accounting for 40% of the total grain yield in China. The rice production directly relates to the grain security, the income growth of farmers, and the social stability of China. Rice planthoppers, comprising Nilaparvata lugens (Stål), Sogatella furcifera (Horváth), and Laodelphax striatellus (Fallén), belong to Hemiptera and currently are the most important insect pests of rice in China and many Asian countries. The rice planthoppers not only damage the rice through directly feeding and spawning, but also spread various viral diseases, which seriously damages the rice production. In China, the perennial damaged area caused by the rice planthoppers and the viral diseases spread by the rice planthoppers is more than 20 million hectares, which is one of the important restraining factors of the rice production.

Because of the fast and good effect, and the convenient use, the chemical prevention is often seen as the most effective method to control insect pests. However, due to the overuse of the toxic pesticide even the highly-toxic pesticide in the long-term insect pest control and the single variety of the pesticide, pathogens, insect pests and weeds have the increased resistance to pesticides and are increasingly rampant, causing the vicious circle, which seriously threatens the safety production of the crops, the ecological environment, the human health, and the export trade. Thus, it is urgent to develop a highly-efficient and safe green pesticide to control the damages of the insect pests.

Controlling the population quantity of the insect pests through stimulating the own defense system of the plants is one important way to develop the highly-efficient and safe green pesticide. Through the long-term evolution, the plants have generated a complete set of defense mechanism to respond to the damages of the phytophagous insects. The defense mechanism includes the constitutive defense and the induced defense. The constitutive defense means: the chemical and physical characteristics of the plants for defending against the phytophagous insects, which exist before being damaged by the phytophagous insects. The induced defense means: some chemical and physical characteristics of the plants for defending against the damages of the phytophagous insects, which are showed after being damaged by the phytophagous insects. The researches on the molecular mechanism underlying induced plant defenses reveal that the induced plant defenses start with the recognition of the plants to signals derived from the phytophagous insects or the pathogens, followed by the activation of various signal pathways mediated by jasmonic acid, salicylic acid, ethylene, and MAPKs (mitogen-activated protein kinases), which finally cause the plants to produce defense responses, such as the increase of the defense-related gene expression level, the accumulation of the defense chemicals, and the release of the volatile compounds. During the above process, the signals derived from the phytophagous insects or the pathogens, and some signal molecules having a low molecule weight in the plants, such as the jasmonic acid, the salicylic acid and the ethylene, play a greatly important role. The synthesis and the application of the natural small molecules and the analogue thereof have played an important role in preventing the plant diseases. Moreover, some compounds, such as BTH (S-methyl1,2,3-benzothiadiazole-7-carbothioate), have been commercially produced and applied. However, nowadays, such researches in the prevention of the plant insect pests are still few, and no product has been applied. The jasmonic acid, the methyl jasmonate and the analogue thereof, Coronalon, have been researched a lot. The researches find that: the exogenous application of JA (jasmonic acid), MeJA (methyl jasmonate) and Coronalon is able to induce the plants to produce the protease inhibitor, the nicotine and the polyphenol oxidase, which have negative effects on the insect pests and are able to induce the plants to release the volatiles to attract natural enemies of insect pests.

### SUMMARY OF THE PRESENT INVENTION

An object of the present invention is to provide a method for stimulating an induced insect resistance of rice, so as to solve problems in prior arts.

The object of the present invention is realized through following technical solutions.

A method for stimulating an induced insect resistance of rice is provided. The method induces the rice to generate a systemic resistance against rice planthoppers through p-Fluorophenoxyacetic acid, wherein the rice planthoppers comprise Nilaparvata lugens (Stål), Sogatella furcifera (Horváth), and Laodelphax striatellus (Fallén).

Preferably, the method comprises steps of: preparing an aqueous solution with the p-Fluorophenoxyacetic acid, wherein a concentration of the p-Fluorophenoxyacetic acid is 20 mg/L-50 mg/L; and, spraying the aqueous solution on stems and leaves of the rice through a sprayer, until leaf blades of the rice become partly wet or totally wet, or the aqueous solution drops from the leaf blades.

Preferably, the method comprises steps of: dissolving the p-Fluorophenoxyacetic acid in a rice culture solution or rice irrigation water with a concentration of 1 mg/L-5 mg/L, and then cultivating the rice therein.

The present invention has following beneficial effects. The compound, p-Fluorophenoxyacetic acid, provided by the present invention is able to stimulate the insect resistance of the rice against the rice planthoppers and maximumly decrease a survival rate of nymphs of the rice planthoppers to below 10%, and has a quite high economic benefit. According to occurrences of insect pests at different ecological regions, the present invention is able to serve as a chemical elicitor, which enables the plants to generate the insect resistance, thereby safely and effectively controlling the insect pests.

These and other objectives, features, and advantages of the present invention will become apparent from the following detailed description, the accompanying drawings, and the appended claims.

### BRIEF DESCRIPTION OF THE DRAWINGS

FIG. 1 shows influences of a root absorption treatment with p-Fluorophenoxyacetic acids having different concentrations on survival rates of nymphs of brown planthopper and white-backed planthopper according to a first preferred embodiment of the present invention.

FIG. 2 shows influences of a spray treatment with p-Fluorophenoxyacetic acids having different concentrations on survival rates of nymphs of brown planthopper and white-backed planthopper according to a second preferred embodiment of the present invention.

### DETAILED DESCRIPTION OF THE PREFERRED EMBODIMENT

The present invention relates to a method for stimulating an induced insect resistance of rice, comprising steps of: applying a p-Fluorophenoxyacetic acid aqueous solution having an effective concentration to the rice; and, after absorbing by the rice, stimulating the insect resistance of the rice, thereby increasing a resistance of the rice against rice planthoppers.

A structure of p-Fluorophenoxyacetic acid provided by the present invention is:

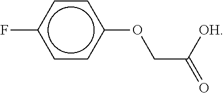

According to the present invention, the p-Fluorophenoxyacetic acid aqueous solution having a bioactivity is applicable to roots, stems, and leaf blades of plants. During application, it is feasible to apply the p-Fluorophenoxyacetic acid aqueous solution onto surfaces of the rice through methods such as spraying, until leaf blades of the rice become partly wet or totally wet, or the aqueous solution drops from the leaf blades. Alternatively, it is feasible to add the p-Fluorophenoxyacetic acid into a nutrient solution required for growth of the rice or a water supply system; no matter a prepared agent is applied at any time of day or night, a good insect resistance is always generated, and the agent is preferably applied in an active growth phase of the plants. The induced insect resistance can be stimulated no matter rice plants are infested or non-infested by the rice planthoppers and last until the rice is harvested. It is noted that the agent should be applied 2 hours before raining or snowing, so as not to affect an effect of the agent. After applying for a period of time, if the induced insect resistance is found to be weakened (for example the number of insect pests increases), it is feasible to apply the agent again for increasing the resistance.

In order to stimulate the induced insect resistance in the plants, an effective number of bioactive components are required, and the number of the bioactive components varies in a large range and relies on various factors, such as a type and a growth phase of the plants, a planting density of the plants, and a weather condition. Generally, for per mu of rice field, 0.2-20 g of bioactive components are enough to stimulate the induced insect resistance of the rice. After optimizing, for per mu of rice field, 0.1-10 g of bioactive components are enough to stimulate the induced insect resistance.

The induced insect resistance of the plants, stimulated by the agent having the bioactivity provided by the present invention, is effective to the rice planthoppers in the rice field, comprising brown planthopper, white-backed planthopper and small brown planthopper.

Application methods of the compound provided by the present invention are further described in detail with following preferred embodiments, for better understanding the present invention. It is noted that the preferred embodiments are exemplary only and not intended to be limiting.

First preferred embodiment: Decrease of survival rate of rice planthopper nymphs through root absorption treatment of rice with p-Fluorophenoxyacetic acid

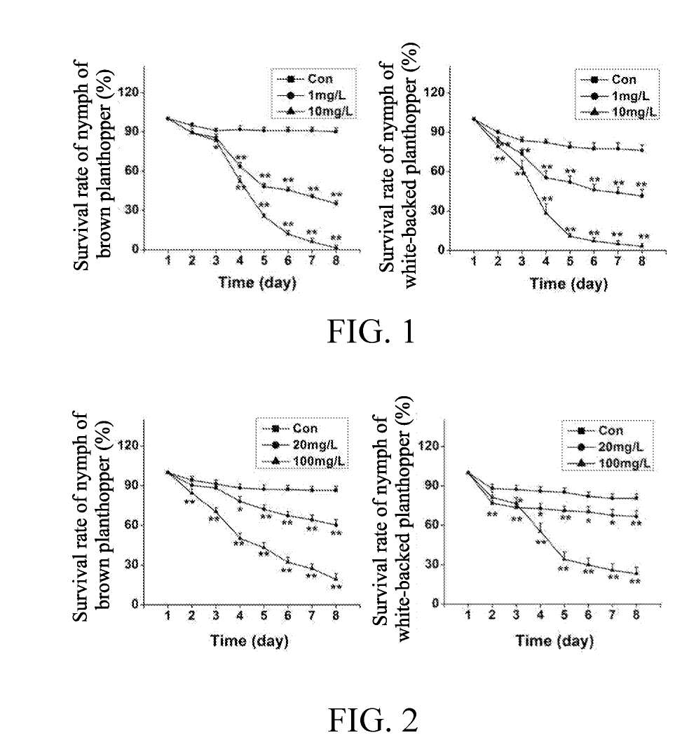

According to the first preferred embodiment of the present invention, the applied p-Fluorophenoxyacetic acids have concentrations of 1 mg/L and 10 mg/L. The rice is cultivated through the nutrient solution, and planted by each individual rice plant; the p-Fluorophenoxyacetic acid is added into the nutrient solution until a final concentration is 1 mg/L or 10 mg/L; and the nutrient solution without adding the p-Fluorophenoxyacetic acid is adopted as a control group. After treating with the p-Fluorophenoxyacetic acid for 12 hours, a special glass cover (with a diameter of 4 cm, a height of 8 cm, and 48 holes having a diameter of 0.8 mm uniformly provided on a wall) is placed on a stem of each individual rice plant, and 15 newly-hatched nymphs of the brown planthopper or the white-backed planthopper are introduced into each glass cover, wherein a top part of each glass cover is sealed by a circular sponge. The experiment is conducted in a phytotron with a temperature of 28±2° C., a humidity of 70-80% and 14 hours of illumination, survival numbers of the nymphs of the brown planthopper or the white-backed planthopper on each plant are recorded daily, and the experiment is repeated for 10 times. It can be seen from FIG. 1 that: from the 2^{nd} day after treating with the p-Fluorophenoxyacetic acid, survival rates of the nymphs of the brown planthopper and the white-backed planthopper are decreased obviously. For the rice which is treated with the p-Fluorophenoxyacetic acid having the concentration of 1 mg/L, a survival rate of the brown planthopper is 35.1% on the 8^{th} day, which is obviously lower than a survival rate of the brown planthopper of the control group of 90.3%; and for the rice which is treated with the p-Fluorophenoxyacetic acid having the concentration of 10 mg/L, a survival rate of the brown planthopper is merely 1.5% on the 8^{th} day. Meanwhile, for the rice which is treated with the p-Fluorophenoxyacetic acid having the concentration of 1 mg/L, a survival rate of the white-backed planthopper is 41.3% on the 8^{th} day, which is obviously lower than a survival rate of the white-backed planthopper of the control group of 90.5%; and, for the rice which is treated with the p-Fluorophenoxyacetic acid having the concentration of 10 mg/L, a survival rate of the brown planthopper is merely 3.1% on the 8^{th} day. Above results show that: a root absorption treatment with the p-Fluorophenoxyacetic acid obviously increases a direct resistance of the rice against the nymphs of the rice planthoppers.

Second preferred embodiment: Increase of resistance of rice against nymphs of rice planthoppers through spray treatment with p-Fluorophenoxyacetic acid

According to the second preferred embodiment of the present invention, the applied p-Fluorophenoxyacetic acids have concentrations of 20 mg/L and 100 mg/L. The rice is cultivated through the nutrient solution, and planted by each individual rice plant; the p-Fluorophenoxyacetic acid is prepared with water to have a certain concentration (20 mg/L or 100 mg/L), and thereafter stems and leaves of the rice are treated with spraying through a small sprayer; and tap water is adopted as a control group. After drops on the stems and leaves of the rice are totally dry, a special glass cover (with a diameter of 4 cm, a height of 8 cm, and 48 holes having a diameter of 0.8 mm uniformly provided on a wall) is placed on a stem of each individual rice plant, and 15 newly-hatched nymphs of the brown planthopper or the white-backed planthopper are introduced into each glass cover, wherein a top part of each glass cover is sealed by a circular sponge. The experiment is conducted in a phytotron with a temperature of 28±2° C., a humidity of 70-80% and 14 hours of illumination, survival numbers of the nymphs of the brown planthopper and the white-backed planthopper on each plant are recorded daily, and the experiment is repeated for 10 times. It can be seen from FIG. 2 that: from the 2^{nd} day after treating with the p-Fluorophenoxyacetic acid, survival rates of the nymphs of the brown planthopper and the white-backed planthopper are decreased obviously. For the rice which is treated with the p-Fluorophenoxyacetic acid having the concentration of 20 mg/L, a survival rate of the brown planthopper is 60.3% on the 8^{th} day, which is obviously lower than a survival rate of the brown planthopper of the control group of 86.5%; and for the rice which is treated with the p-Fluorophenoxyacetic acid having the concentration of 100 mg/L, a survival rate of the brown planthopper is merely 19.2% on the 8^{th} day. Meanwhile, for the rice which is treated with the p-Fluorophenoxyacetic acid having the concentration of 20 mg/L, a survival rate of the white-backed planthopper is 66.1% on the 8^{th} day, which is obviously lower than a survival rate of the white-backed planthopper of the control group of 81.4%; and, for the rice which is treated with the p-Fluorophenoxyacetic acid having the concentration of 100 mg/L, a survival rate of the brown planthopper is merely 23.2% on the 8^{th} day. Above results show that: a direct resistance of the rice against the nymphs of the rice planthoppers is obviously increased through a spray treatment with the p-Fluorophenoxyacetic acid.

Third preferred embodiment: No effect of p-Fluorophenoxyacetic acid on survival of rice planthoppers

In order to exclude possible influences of the p-Fluorophenoxyacetic acid itself on a survival rate of nymphs of the rice planthoppers, the third preferred embodiment of the present invention measures stomach toxicity and contact toxicity of the p-Fluorophenoxyacetic acids having different concentrations on the nymphs of the rice planthoppers. In the experiment for measuring the stomach toxicity of the p-Fluorophenoxyacetic acid on the nymphs of the rice planthoppers, the p-Fluorophenoxyacetic acids, having concentrations of 5 mg/L, 20 mg/L and 50 mg/L, are respectively added into planthopper artificial diets, and another planthopper artificial diet not containing the p-Fluorophenoxyacetic acid is adopted as control. The planthopper artificial diets containing the p-Fluorophenoxyacetic acids of different concentrations are respectively wrapped by a Parafilm sealing film and then placed at two ends (20 μL at one end) of a glass two-way tube having a diameter of 4 cm and a height of 8 cm, and 15 newly-hatched nymphs of the white-backed planthopper are introduced into each tube; wherein the glass two-way tube, in which the planthopper artificial diet not containing the p-Fluorophenoxyacetic acid is placed, is adopted as a control group. All the glass two-way tubes are placed in a phytotron (with a temperature of 28° C. and 12 hours of illumination), the artificial diet in each tube is changed once a day, and the survival number of the nymphs of the white-backed planthopper in each tube is recoded daily. The experiment is repeated for 10 times. Results thereof show that: adding the p-Fluorophenoxyacetic acid with a test concentration into the artificial diet does not affect a survival rate of the nymphs of the white-backed planthopper; for the artificial diets containing the p-Fluorophenoxyacetic acids respectively with the concentrations of 0 mg/L, 5 mg/L, 20 mg/L and 50 mg/L, the survival rates of the nymphs of the white-backed planthopper on the 2^{nd} day are respectively 85.7%, 85.5%, 87.4% and 81.3%; and, the survival rates on the 4^{th} day are respectively 56.2%, 58.6%, 54.3% and 57.6%. Thus, the p-Fluorophenoxyacetic acid has no stomach toxicity on the planthoppers.

In the experiment for measuring the contact toxicity of the p-Fluorophenoxyacetic acid on the nymphs of the rice planthoppers, the p-Fluorophenoxyacetic acids respectively having concentrations of 5 mg/L, 20 mg/L, and 50 mg/L are adopted, and distilled water not containing the p-Fluorophenoxyacetic acid is adopted as a control group. Third-instar nymphs of the white-backed planthopper, being narcotized by carbon dioxide, are spotted with the p-Fluorophenoxyacetic acid having the corresponding concentration or the distilled water (1 μL for each planthopper); after waking up, the planthoppers are fed on rice plants having an age of 30 days, wherein 15 planthoppers are fed on each rice plant; and the rice is placed in a phytotron with a temperature of 28±2° C., a humidity of 70-80% and 14 hours of illumination. The experiment is repeated for 10 times. Survival numbers of the nymphs of the planthoppers are observed and recorded respectively 24 hours and 48 hours after treatment. Results thereof show that: 24 hours after treating, for the control group and the p-Fluorophenoxyacetic acids having the concentrations of 5 mg/L, 20 mg/L and 50 mg/L, survival rates of the nymphs of the planthoppers are respectively 93.3%, 92.0%, 93.1%, 92.0%; and 48 hours after treating, the survival rates are respectively 90.2%, 92.0%, 91.6% and 90.8%. The survival rate of each group is not significantly different, illustrating that the p-Fluorophenoxyacetic acid has no contact toxicity on the planthoppers.

Fourth preferred embodiment: Researches about induced mechanism of p-Fluorophenoxyacetic acid

According to the fourth preferred embodiment of the present invention, the applied p-Fluorophenoxyacetic acid has a concentration of 5 mg/L. The rice is cultivated through the nutrient solution, and planted by each individual rice plant; the p-Fluorophenoxyacetic acid is added into the nutrient solution of the rice until a final concentration is 5 mg/L, and another nutrient solution without adding the p-Fluorophenoxyacetic acid is adopted as a control group. The experiment is repeated for 5 times and conduced in a phytotron with a temperature of 28±2° C., a humidity of 70-80%, and 14 hours of illumination. Results thereof show that: 72 hours after treating with the p-Fluorophenoxyacetic acid, contents of 4-hydroxybenzoic acid and γ-aminobutyric acid in the rice obviously increase, wherein the content of the 4-hydroxybenzoic acid of the experimental group is 2.12 times higher than the content of the 4-hydroxybenzoic acid of the control group; and the content of the γ-aminobutyric acid of the experimental group is 2.86 times higher than the content of the γ-aminobutyric acid of the control group. The 4-hydroxybenzoic acid belongs to a phenolic acid defense compound, and the γ-aminobutyric acid belongs to a non-protein amino acid, which have direct toxicity effects on the insect pests and are able to influence a peripheral nervous system of the insects. Treating the rice with the p-Fluorophenoxyacetic acid is able to increase contents of the defense compounds, thereby generating a negative effect on the insect pests and increasing a resistance of the rice against the insect pests.

One skilled in the art will understand that the embodiment of the present invention as shown in the drawings and described above is exemplary only and not to intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for stimulating an induced insect resistance of rice, wherein: the rice is induced to generate a systemic resistance against rice planthoppers through p-Fluorophenoxyacetic acid; and the rice planthoppers comprise Nilaparvata lugens (Stål), Sogatella furcifera (Horváth), and Laodelphax striatellus (Fallén).

2. The method for stimulating the induced insect resistance of the rice, as recited in claim 1, comprising steps of: preparing an aqueous solution with the p-Fluorophenoxyacetic acid, wherein a concentration of the p-Fluorophenoxyacetic acid is 20 mg/L-100 mg/L; and, spraying the aqueous solution on stems and leaves of the rice through a sprayer, until leaf blades of the rice become partly wet or totally wet, or the aqueous solution drops from the leaf blades.

3. The method for stimulating the induced insect resistance of the rice, as recited in claim 1, comprising steps of: dissolving the p-Fluorophenoxyacetic acid in a rice culture solution or rice irrigation water with a concentration of 1 mg/L-10 mg/L, and then cultivating the rice therein.
